(19) United States
(12) Patent Application Publication
(10) Pub. No.: US 2017/0268209 A1
(43) Pub. Date: Sep. 21, 2017

(54) PASSIVE FLUID REGULATION SYSTEM

(71) Applicant: Accurate Site Development, Inc., Naples, FL (US)

(72) Inventors: Jerome J. Guidish, Naples, FL (US); Douglas Guidish, Naples, FL (US)

(21) Appl. No.: 15/612,165

(22) Filed: Jun. 2, 2017

Related U.S. Application Data
(63) Continuation-in-part of application No. 14/573,982, filed on Dec. 17, 2014.
Application No. 14/573,982 is a continuation-in-part of application No. 14/506,911, filed on Oct. 6, 2014.

(51) Int. Cl. E03C 1/05; F16K 37/00; F16K 31/04; F16K 31/06; F16K 5/06

(52) U.S. Cl. CPC E03C 1/057; F16K 31/0675; F16K 5/06; F16K 31/04; F16K 37/0041

(57) ABSTRACT

A system to regulate fluid flow using a single unit is shown and described. The system uses a single valve interposed on at least one fluid supply line. The valve is normally closed, cutting off the flow of fluid in the at least one fluid supply line. The valve is in electrical communication with an occupancy sensor such that when the occupancy sensor is activated the valve is signaled to open, allowing flow of fluid in the fluid supply line.

### CROSS-REFERENCE TO RELATED APPLICATIONS

This application claims the benefit of priority as a continuation-in-part to U.S. patent application Ser. No. 14/506,911, filed on Oct. 6, 2014, which is currently pending, and also claims the benefit of priority as a continuation-in-part to U.S. patent application Ser. No. 14/573,982, filed on Dec. 17, 2014, which is presently pending.

### BACKGROUND OF THE INVENTION

1. Field of the Invention

This invention is directed to a passive fluid regulation system, and more specifically this invention is related to fluid control to a fixture via operation of a light switch.

2. Background of the Invention

Many household and commercial devices are supplied with pressurized fluids for activities related to heating, cooling, cooking, and waste removal. Exemplary fluids include fuel products (oil, methane, propane), and cooking and waste removal agents (water and air).

Water is the most ubiquitous of these agents. A single family residence contains multiple sill cocks, faucets, weather exposed conduits and valves servicing standard fixtures, such as sinks, toilets, and washers. Water outlets are multiplied for large commercial accommodations, such as hotels, office buildings, commercial kitchens, restaurants, and trailer and RV parks.

Failure (leakage, freeze damage) of these fluid lines at a minimum results in substantial fluid loss. In worse case scenarios, substantial property damage or even loss of life occurs.

Toilets, faucets, showers, and other bathroom fixtures will all eventually leak. Toilets in particular develop slow leaks as a result of a damaged flapper, mineral buildup that prevents proper sealing, or a leaky water inlet valve.

In a standard toilet, the ballcock assembly controls the flow of water into the tank from a point of ingress at the bottom of the tank. The tank houses a float attached to the distal end of a lever. The proximal end of the lever is mechanically linked to a water inlet valve positioned between the proximal end of the lever and the ballcock valve. When the water level in the toilet tank rises to a certain height, the float pushes up on the distal end of the lever, which causes the proximal end to close the water inlet valve. When the water is below that height, the float does not provide a force on the distal end of the lever, and water is allowed to flow into the tank. If leaks exist in the tank or inlet valve, or if the toilet begins to overflow, water continues to flow into the tank and eventually spills over onto the floor. If the flapper valve does not seal completely, then the toilet tank cannot reach required the water level so that the water inlet valve closes, and the tank will continuously fill. Thus, leaks can cause a toilet to constantly fill and to potentially spew water.

Even for a single residential toilet, such leaks can waste several thousands of gallons of water a year. This can result in higher water bills or depleted well reserves. Additionally, wasting water has environmental impacts, especially in drought-ridden areas. These problems are further exacerbated in commercial or institutional settings where several toilets could simultaneously be affected.

The typical remedy for a slow leak in a toilet is to replace the damaged component. However, this only addresses the problem after the leak is detected. If the leak is in a toilet that is seldom or intermittently used, then it might avoid detection for a prolonged period of time. If the leak is detected early, then the water inlet valve can be shut off, but the user would have to open and close the valve before and after each and every use of the toilet. Such a situation is cumbersome, and at least some users are likely to forget to close the valve after use.

Some prior art devices have attempted to address the problem of leaks. For instance, some devices use timers to control the flow of water into a tank, others use flow meters, and still others use level sensors in the toilet bowl. However, these devices simply shutoff the water to the toilet until the leak can be remedied. The toilet cannot be used in the interim without manually overriding the system, and if the system is manually overridden, then the user must remember to reactivate it. Additionally, these systems are or use components that are relatively expensive.

Besides water lines, fuel lines, especially natural gas and liquefied petroleum gas, are commonly found in both residential and commercial settings for cooking and heating applications. A common concern among natural gas users is that the gas to the oven or stove has been left flowing. A natural gas stove can release gas even though no flame is present as long as a user actuated valve is not completely closed. Without the presence of a flame or the heat from combustion, the user might not even be aware of the leak. If the leak goes unchecked for an extended period of time, such as overnight, this could cause sickness or death from inhalation or possibly lead to an explosion. At the very least, it will cause an increase in the utility bill. Such concerns apply equally to those who use liquefied petroleum gas, liquid propane, and propane gas for domestic applications.

Sophisticated sensors can be used to detect fuel leaks when they occur. However, these sensors only identify the problem after it happens. In the interim, they do not mitigate the damages that occur. Furthermore, these sensors are expensive to implement and maintain.

Therefore, a need exists in the art for a system to regulate the flow of a fluid to a fixture such that leaks are unable to increase utility bills, deplete reserves, harm the environment, or cause a catastrophic failure. The system should require only standard “off the shelf” parts. The system should be easy to operate, and obvious to actuate.

### SUMMARY OF THE INVENTION

An object of the present invention is to provide a fluid regulation system that overcomes many of the limitations of the prior art.

A further object of the present invention is to provide a fluid regulation system that mitigates the problems caused by leaks. A feature of the present invention is that the fluid regulation system prevents fluid from reaching the fixture. An advantage of the present invention is that even undetected leaks cannot cause a substantial increase in utility bills or cause a substantial depletion in reserves inasmuch as those undetected leaks are located downstream from where fluid shut off occurs. As such, actuation of the system is not dependent on the existence or detection of a leak or malfunction. Another advantage is that the leaks are prevented from reaching the point of causing substantial damage to persons or property.

Yet another object of the present invention is to provide a fluid regulation system that can work in a variety of applications. A feature of the present invention is that the system can be adapted to regulate, among other things, water flow to bathroom fixtures, either individually or to the entire bathroom, and to regulate fuel flow to residential and commercial applications, such as kitchen appliances. An advantage of the present invention is that safety is improved in those applications, while operational costs are reduced.

Another object of the present invention is to provide a fluid regulation system that is passive in nature. A feature of the present invention is that a pressurized fluid is made accessible to a fixture in a room when a light switch in the same room is actuated. An advantage of the present invention is that when a user enters a room, he or she will naturally turn on the lights, which will initiate supply of pressurized fluid to the fixture. When the user exits the room, he or she will naturally turn off the lights, thereby shutting off flow of pressurized fluid to the fixture.

An additional object of the present invention is to provide a fluid regulation system that is easy and safe to install. A feature of the present invention is that the present invention is considered a low voltage Class 2 circuit, which operates at lower energy and improves fire safety. An advantage of the present invention is that the components are all Underwriters Laboratories (UL®) listed and readily available commercially. Another advantage of the present invention is that the components are relatively inexpensive compared to other fluid regulation devices.

Yet another object of the present invention is to provide a wireless fluid regulation system. A feature of the present invention is that a light switch is coupled with a wireless transmitter and a solenoid is coupled with a wireless receiver such that activation of the light switch causes a signal to be sent to the receiver, opening the solenoid. An advantage of the present invention is that it obviates the need for a dedicated wire run between the light switch and the solenoid, thereby simplifying installation and costs.

Briefly, the present invention provides a system for regulating fluid flow, the system comprising a solenoid valve in fluid communication with, and regulating flow in a fluid supply line; a light switch that controls a light; and a transformer with a primary side and a secondary side, wherein the primary side is placed in intermediate electrical communication with the light switch and the light, wherein the secondary side is in electrical communication with the solenoid valve, and wherein the solenoid valve allows flow through the fluid supply line when the light switch is activated and prevents flow through the fluid supply line when the light switch is deactivated.

The present invention also provides a system to regulate fluid flow, the system comprising a solenoid valve in fluid communication with, and regulating flow in, a fluid supply line; a motion-activated switch; and a transformer with a primary side and a secondary side, wherein the primary side is placed in electrical communication with the motion activated switch and the secondary side is in electrical communication with the solenoid valve, and wherein the solenoid valve allows flow through the fluid supply line when the motion activated switch is actuated and prevents flow through the fluid supply line when the motion activated switch is not triggered.

The present invention further provides a system to regulate fluid flow, the system comprising a plurality of solenoid valves interposed on a plurality of fluid supply lines; a light switch that controls a light; and a transformer with a primary side and a secondary side, wherein the primary side is placed in intermediate electrical communication with the light switch and the light, wherein the secondary side has a plurality of windings in electrical communication with the plurality of solenoid valves such that each of the plurality of solenoid valves is connected to its own winding, and wherein each solenoid valve allows flow through its respective fluid supply line when the light switch is activated and prevents flow through its respective fluid supply line when the light switch is deactivated.

The present invention additionally provides a system to regulate fluid flow, said system comprising: a light switch that controls a light, wherein the light switch is in electrical communication with a wireless transmitter; and at least one electrical valve interposed on at least one fluid supply line wherein said at least one valve is normally closed, cutting off the flow of fluid in the at least one fluid supply line, wherein the at least one valve is in electrical communication with a wireless receiver such that when the light switch is activated the wireless transmitter signals the wireless receiver to open the valve, allowing flow of fluid in the fluid supply line.

The present invention still further provides a system to regulate fluid flow, said system comprising at least one valve interposed on at least one fluid supply line wherein said at least one valve is normally closed, stopping the flow of fluid in the at least one fluid supply line, wherein the at least one valve is in electrical communication with a photocell switch such that when light is detected the photocell switch allows electrical current flow to the valve, opening the valve and allowing the flow of fluid in the fluid supply line.

### BRIEF DESCRIPTION OF THE DRAWINGS

The invention together with the above and other objects and advantages will be best understood from the following detailed description of the preferred embodiment of the invention shown in the accompanying drawings, wherein:

FIG. 1 is a process flow chart describing the general operation of the present invention;

FIG. 2 is a diagram of the fluid regulation system, in accordance with the features of the present invention;

FIG. 3 is a schematic of the electric circuit, in accordance with the features of the present invention;

FIG. 4 is a detailed view of the solenoid valve as shown in FIG. 1;

FIG. 5 is a view of an entire bathroom regulated with the present invention;

FIG. 6 depicts another embodiment of the present invention;

FIGS. 7A and 7B depict an overview of a further embodiment of a sensor used in one embodiment of the present invention;

FIGS. 8A and 8B depict an overview of a further embodiment of a valve assembly used in one embodiment of the present invention;

FIG. 9 depicts an overview of a further embodiment of the present invention;

FIG. 10 depicts an overview of an additional embodiment of the present invention;

FIG. 11 depicts an exploded view of the embodiment of the present invention shown in FIG. 10;

FIG. 12 depicts a detailed view of the circuit board used in the embodiment of the invention shown in FIGS. 11 and 12; and

FIG. 13 depicts an overview of an embodiment of the invention.

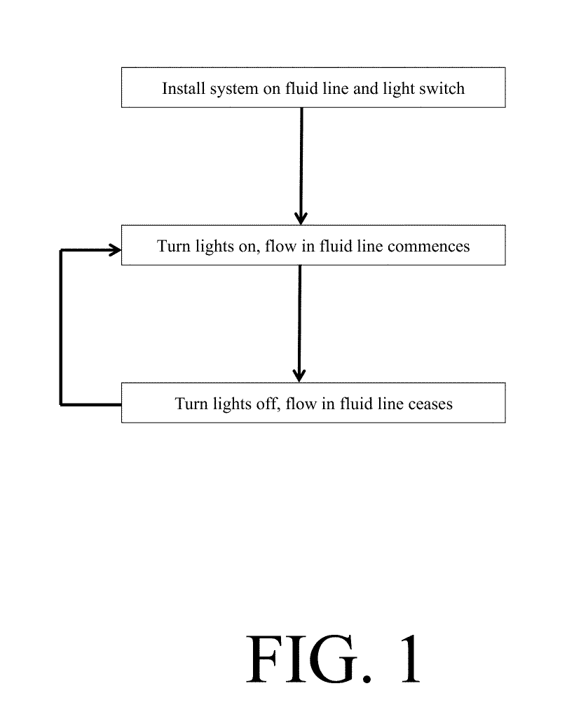

### DETAILED DESCRIPTION OF THE INVENTION

The foregoing summary, as well as the following detailed description of certain embodiments of the present invention, will be better understood when read in conjunction with the appended drawings.

As used herein, an element step recited in the singular and preceded with the word “a” or “an” should be understood as not excluding plural said elements or steps, unless such exclusion is explicitly stated. Furthermore, the references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

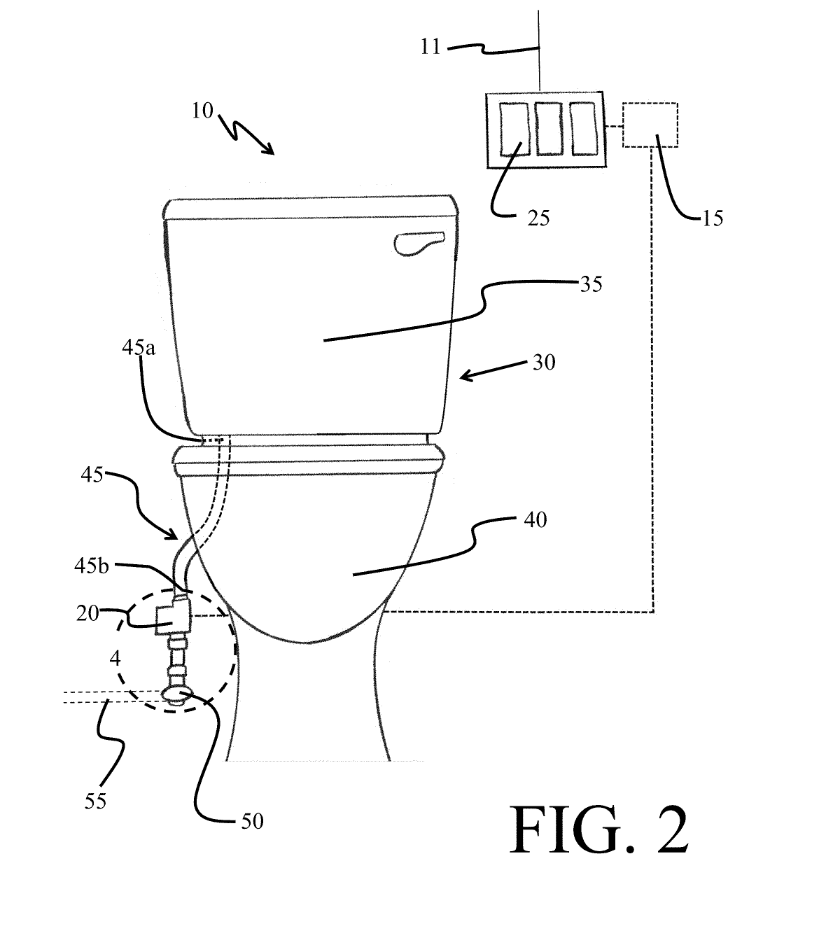

The present invention is directed to a passive fluid regulation system, designated as numeral 10 in FIG. 2. The system 10 is placed downstream and in fluid communication with a fluid line 55 that leads to a fixture such that the system is positioned upstream of the fixture. The system 10 is normally in the closed position, i.e., it prevents the flow of fluid in the fluid line. When the system 10 is activated, it changes to the open position, allowing the flow of fluid within the line. In a preferred embodiment of the present invention, the system 10 is activated by a light switch. The light switch controls the lights to the room containing the fixture and also the flow of fluid in the fluid line. A particular fixture that could benefit greatly from the invented system 10 is a toilet. The following description and figures will relate to the invented system's application to a toilet, but other uses are also envisioned.

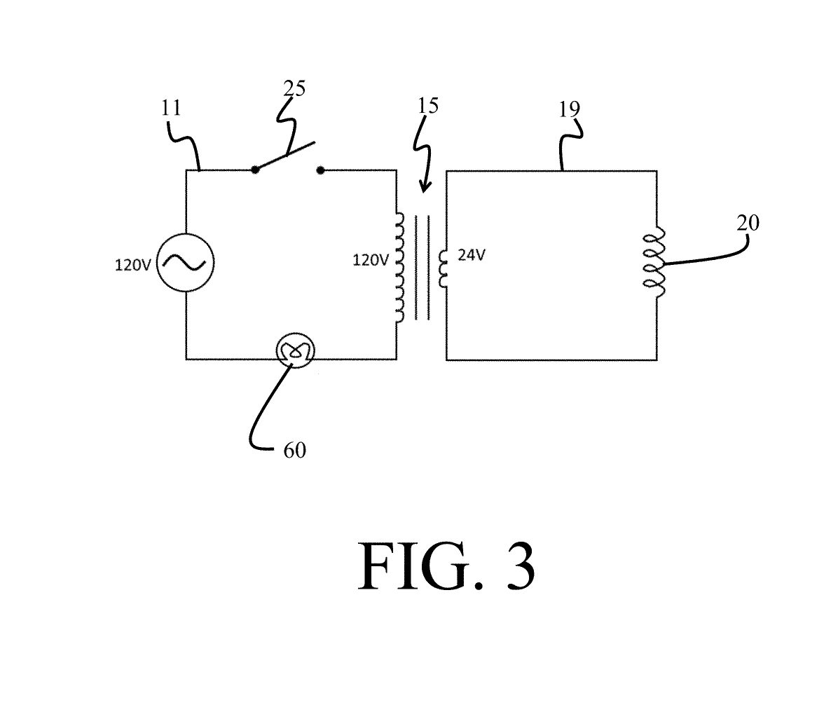

FIGS. 2 and 3 show the general arrangement of the fluid regulating system 10. The system primarily consists of a transformer 15 which steps down household AC voltage to a lower voltage. A rectifier or a rectifier and smoothing filter could be used in combination with the transformer 15 such that the household AC voltage and current are transformed to DC current. The transformer 15 is in electrical communication with a light switch 25, such that the switch is energized by the 120 V circuit. The transformer is further in electrical communication, via a low-voltage line 19 with a solenoid valve 20. The transformer 15 is shown in phantom in FIG. 2 because it is preferably placed behind the wall for electrical insulation, safety, and aesthetic reasons. The solenoid valve 20 controls water flow to a fixture, such as a toilet 30, in one embodiment. The toilet 30 consists of a tank 35 and a bowl 40, in the depicted embodiment. The tank 35 is supplied with water via an inlet line 45. The inlet line 45 is typically a flexible conduit made from plastic, rubber, or braided metal strands, that inlet line positioned downstream of the solenoid valve 20. A first end 45a of the inlet line 45 typically features a threaded connector that attaches to the ballcock assembly in the toilet tank 35. A second end 45b of the inlet line 45 connects to the solenoid valve 20. The solenoid valve 20 is in fluid communication with a water shutoff valve 50, which in turn is in fluid communication with a premises supply line 55.

In a standard toilet 30, the water shutoff valve 50 is normally in the open position such that water from the supply line 55 can flow into the tank 35. By placing the solenoid valve 20 intermediate of the water shutoff valve 50 and the fluid inlet line 45, the solenoid valve 20 instead regulates flow of water into the tank 35. The solenoid valve 20 is normally in the closed position such that water cannot flow through it. Therefore, the solenoid valve 20 must be activated to allow flow. However, if the toilet tank 35 is already full, then flow will not commence inasmuch as the ball valve within the tank prevents additional water from entering the tank.

Activation of the solenoid valve 20, thereby opening or closing the flow, is controlled by the light switch 25 via the transformer 15. In an unpowered state, the solenoid valve 20 is in a closed position, preventing flow from the supply line 55 to the toilet fixture 40.

FIG. 3 shows the schematic diagram of the solenoid circuit. In the United States, a standard light switch carries a standard voltage of 120V AC. The light switch 25 is connected in series to the primary side of the transformer 15. The transformer 15 is then connected in series to a light 60. In this way, turning the lights on will activate the transformer as well. The transformer 15 steps down the voltage on the secondary side to a lower level, such as 12 V or 24 V AC. When the light switch 25 is activated, current flows through the primary side of the transformer 15 and through the light 60. On the secondary side of the transformer 15, the flow is through a low-voltage solenoid valve 20. The normally closed solenoid 20 is actuated to the open position, allowing the flow of water. When the light switch is turned off, current flow through the transformer 15 and light 60 stops, and the solenoid valve 20 returns to the closed position.

In an embodiment of the invention, the components for the system are substantially all UL® listed and commercially available. A suitable transformer 15 is model 125C-A, manufactured by Heath Zenith (Bowling Green, Ky.). To connect to the home or building power supply, the transformer has three primary side connections: hot, neutral, and ground. It also has three secondary side connections for 8, 10, and 24 V AC connections. An embodiment of the solenoid valve is a ¾″ 2BCV Series 24 VAC solenoid available from WIC Valve (San Jose, Calif.). Suitable wire for use with the present invention is 18 AWG 3 wire made by Alan Wire (Sikeston, Mo.).

These components are all Class 2 components under the National Electrical Code®, produced by the National Fire Protection Association. This code has largely been adopted by most state and local jurisdictions. Class 2 circuits are considered low voltage circuits, having a circuit voltage less than 30 V AC. Class 2 circuits are considered to be safer than Class 1 circuits from a fire prevention and electric shock standpoint. Class 2 circuits are also less expensive to install. Thus, designing the presently invented system 10 to be class 2 compliant offers several of the above identified cost and safety advantages.

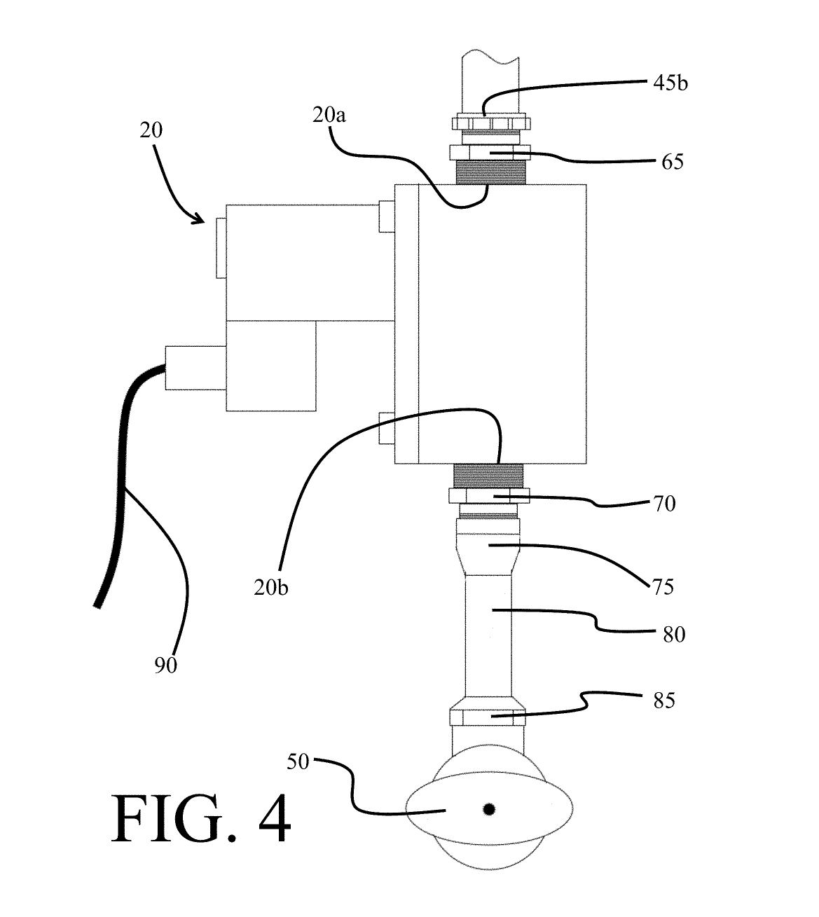

FIG. 4 shows the solenoid valve 20 adapted to an existing toilet's plumbing. On the downstream end 20a of the solenoid valve 20, a male-male connector 65 reduces the connection from the ¾″ solenoid valve 20 to the ½″ second end 45b of the inlet line 45. On the upstream end, a male-male ¾″ to ½″ connector 70, a flared fitting 75, a small section of conduit such as copper pipe 80, and a ⅜″ compression fitting 85 connect the solenoid valve 20 to the water shutoff valve 50. Thread seal tape, or other thread sealants, can optionally be used to ensure that the fittings do not leak. Further, while a combination of the aforementioned individual fittings was described, these fittings could be incorporated into larger, integral components or contained in a housing unit adapted to receive two ends of a flow line. A two-wire electrically conductive cable 90 connects the solenoid valve 20 to the transformer 15; however, three-wire cable could also be used to ground the solenoid. Preferably, the cable 90 is concealed (e.g., behind a wall or ceiling panel) for aesthetic reasons.

The system 10 is described as “passive” because it does not have to be intentionally controlled or actuated by a bathroom entrant. For example, a person using the restroom would naturally turn the lights on when he or she enters. This action starts the flow of water to the toilet tank. When the person leaves the restroom, he or she will then turn the lights off, thereby ceasing the flow of water to the toilet tank. In this way, the user does not have to take action independent of what he or she would normally do under the circumstances. Nevertheless, the system is still saving water.

In some instances, users will forget to turn the lights off. Even in those circumstances, the system will still save more water than would ordinarily be saved because the lights will eventually be turned off, such as during the overnight hours.

In one embodiment of the system, the light switch is replaced with a motion activated switch. Motion activated switches typically use an infrared sensor to detect a change in temperature, such as when a person walks by. The switch will then turn itself off after a preset amount of time. Thus, in this embodiment, current flow through the system does not require the user to physically flip a switch upon entering the room. Instead, simply walking into the room will activate the system. This design is especially applicable to rooms that are well-lit during the daylight hours, such that a person entering the room might not turn the lights on.

The motion activated switch can be connected to a light or the switch can operate independently of the main room light. Alternatively, the motion activated switch can activate a secondary light, such as a ground level night light. Some people prefer to avoid turning on the lights upon waking up in the night to use the restroom or get a drink of water. Using a motion activated switch to turn on the water in the restroom and a ground level night light would help prevent falls, while also avoiding the shock of bright lights during a brief moment of being awake.

In another embodiment, the transformer 15 has multiple windings on the secondary side such that a plurality of solenoids can be connected to the transformer 15. For instance, if the secondary side of the transformer had five 24V windings, then flow to the hot and cold lines of a faucet, the hot and cold lines of a shower, and the inlet line for a toilet could all be tied to operation of a light switch 25. When the light switch 25 is “on,” then flow to each fixture would be allowed. When the light switch 25 is “off,” flow to all of the fixtures would be shut off. In this way, flow of water to all of the water fixtures in a room could be regulated simultaneously.

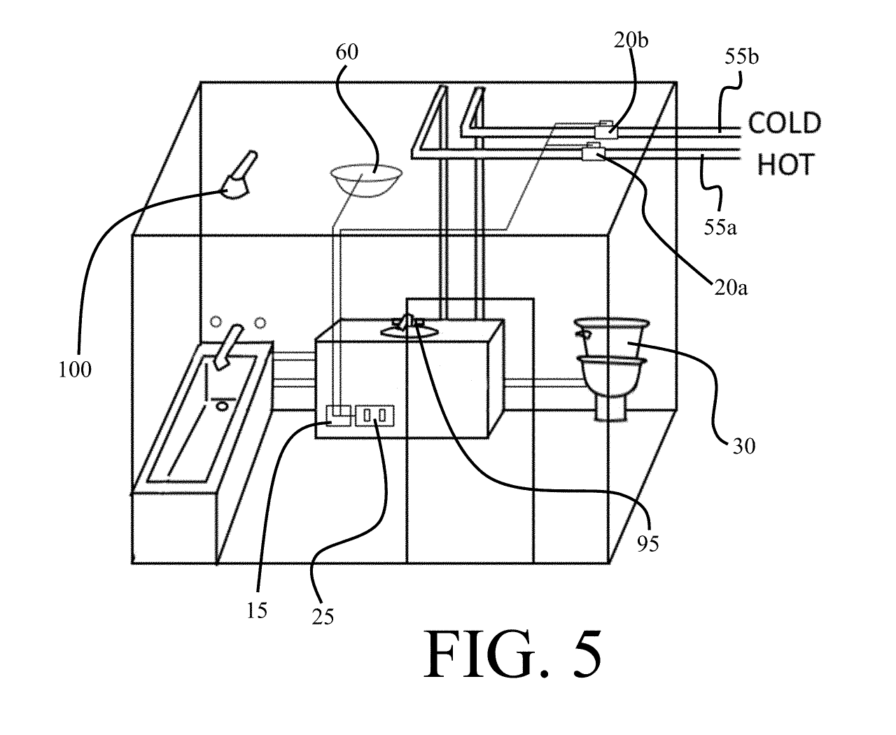

Alternatively, as depicted in FIG. 5, the flow of water to all of the fixtures in a room can be regulated by placing the solenoid valve on the supply lines entering the room. FIG. 5 shows a hot water supply line 55a and a cold water supply line 55b entering a restroom. The supply lines 55a and 55b are located in the ceiling in this depiction, but they could also be located in the walls or floor joists depending on the construction of the house. The hot water supply line 55a runs to a sink faucet 95 and shower 100, while the cold water supply line runs to the sink faucet 95, shower 100, and toilet 30. A first solenoid valve 20a and a second solenoid valve 20b are interposed on the hot water supply line 55a and the cold water supply line 55b, respectively. The solenoid valves 20a, 20b are in electrical communication with the transformer 15, which is connected in series with the light switch 25 and the light 60.

When the light 60 in the bathroom is off, the solenoid valves 20a, 20b block the flow of water on the supply lines 55a, 55b, thereby preventing water from reaching the bathroom fixtures. When the light 60 is turned on, water flow is allowed to reach the bathroom fixtures. Accordingly, this embodiment provides the same benefit as installing a solenoid valve on each fixture; however, this embodiment provides the additional advantage that the components can be completely hidden in the ceiling, floor, or wall and reduces the number of installations. The size of the valve that is needed can vary depending on the size of the water pipe running through the home, which can typically vary from one half inch to one inch. The valve for the hot water line should be capable of operating at temperatures of up to 140° F., which is typically the hottest temperature at which water is stored. More commonly, the water in the hot water line will be below 130° F. so as to avoid scalds.

The embodiment described in FIG. 5 could also be applied to fuel lines in a kitchen. In this configuration, the solenoid valve would be placed on the gas line entering the kitchen. This configuration applies especially well to commercial kitchens. When the kitchen in a restaurant, bakery, or hotel is closed and the employees leave, the lights are typically shutoff in the kitchen. In doing so, the gas supplied to the kitchen equipment would also be shut off by the solenoid valve on the gas mainline. The worker who shuts the lights off in the kitchen may not even know or realize that he or she is also shutting off the gas to supply.

The system 10 has particular applicability for rental homes, hotels, vacation homes, and other places that are or could be intermittently used. Rental homes and vacation homes, especially, often go through periods of prolonged disuse. Prior to leaving, most people make a point to shut off all the lights in the home; however, most people do not think to shut off the water or fuel supply. Use of the invented system 10 will ensure that shutting off the lights will also protect against leaks in water fixtures and the accumulation of fuel gas in the home. In a particular embodiment, the pipes that are shutoff are wrapped in heat tape or another insulating material, so as to help prevent the pipes from freezing during prolonged shutoff over the winter months. These measures save money and avoid potential dangerous situations.

In hotels, after a guest leaves, the guest or cleaning service will usually shut off all of the lights in the room. Moreover, in some European hotels, the guest must insert a keycard into a slot to turn on the lights. Such a system could easily be modified to also energize a solenoid to allow flow to the bathroom. Again, use of the invented system in these circumstances will prevent slow leaks in the water fixtures from turning into large expenses on the water bill.

### Wireless System

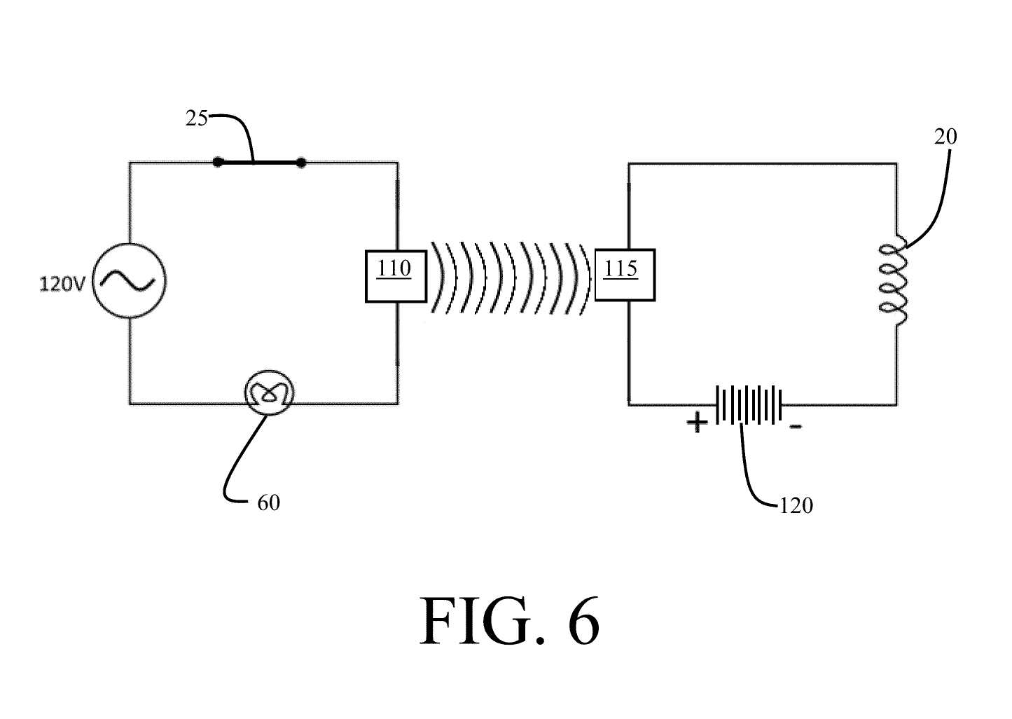

In another embodiment of the presently invented system (see FIG. 6), the light switch 25 is in communication with the solenoid 20, using a wireless means, such as radio frequency communication. In this embodiment, there is no need to run wires through or along a wall.

In one wireless embodiment, a wireless transmitter 110 is electrically and physically coupled to the light switch 25, and a wireless receiver 115 is electrically and physically coupled with the solenoid valve 20. As can be seen in FIG. 6, the light switch 25 is in electrical communication with the wireless transmitter 110. The wireless transmitter 110 can operate using a variety of signals, including RF, Bluetooth, Wi-Fi, and IR, among others. In one embodiment, the wireless transmitter 110 transmits an RF signal in the ISM bands. Light switches with incorporated RF transmitters are commercially available from such companies as Lutron Electronics Co., Inc. (Coopersburg, Pa.). Additionally, wireless transmitter/receiver chipsets are commercially available and are relatively inexpensive. Such commercial chipsets can be used in the present invention.

In another embodiment, the wireless transmitter 115 is installed by retrofitting on top of a light switch 25. In this embodiment, as the light switch is toggled, the wireless transmitter likewise changes position. In one embodiment, the physical movement of a transmitter element generates electrical current to power the transmitter radio signal sending circuits.

The solenoid valve 20 is in electrical communication with the wireless receiver 115. The wireless receiver 115 is adapted to receive signals from the wireless transmitter 110. The wireless receiver 115 is typically supplied with power from a battery; however, other power supply means can be provided, such as a wall plug. Additionally, the battery can be rechargeable. Suitable charging means include wall plugs, inductive chargers, non-contact magnetic chargers, solar cells, and microwave or other wireless power transmission means. As in previous embodiments, the solenoid 20 is normally closed such that no fluid flows in the fluid line 55 when the solenoid is not energized. When the light switch 25 is actuated, such that the circuit from the power source to the light is closed, the light 60 turns on, and the wireless transmitter 110 sends a signal to the wireless transmitter 115, which energizes and opens the solenoid valve 20. Thus, with the solenoid valve opened, fluid is able to flow through the fluid line 55. When the light 60 is shut off (i.e., when the electrical circuit from the 120V power supply to the light switch 25, and therefore to the transmitter 110, is opened), the wireless transmitter 110 stops signaling the wireless receiver 115, thereby returning the solenoid valve 20 to the closed position.

Other wireless embodiments are envisioned. In one embodiment, the solenoid valve 20 is triggered by a photocell switch. The photocell uses a photoresistor to detect a change in the level of lighting. Photoresistors decrease in resistance as the intensity of the illumination increases. Typically, bathroom lighting provides at least 50 lux of lighting, which is sufficient to trigger a response in many commercially available photoresistors and photocell switches. In response to the lighting, the photocell switch allows flow of current to the solenoid, opening the normally closed valve.

If the solenoid portion of the circuit depicted in FIG. 6 uses AC power, such as through a wall plug, then the power is preferably stepped down to a level of 24 V to 12 V. The voltage step down can be accomplished using a transformer located on the device or in a wall pack located near the outlet. Because the power input is AC, the solenoid is preferably AC to avoid chattering. Many commercially available wireless receivers can operate using either AC or DC power, so the wireless receiver can operate directly off the AC power supply, directly from a battery, or a combination thereof, in cases of power grid failure.

If the solenoid portion of the circuit depicted in FIG. 6 uses DC power, such as through a battery, then several options exist to supply the proper level of power to the solenoid. In one embodiment, a large-capacity, rechargeable battery pack is provided to power the 12 V to 24 V solenoid. Preferably, the solenoid portion of the circuit also contains a microcontroller with a timer. In that way, the microcontroller shuts off current to the solenoid after a preprogrammed amount of time. For instance, if the valve is installed on a single toilet, then the preprogrammed time could be 30 seconds to one minute, such that the microcontroller holds the valve open for a time sufficient to fill the toilet tank. After the preprogrammed time, the valve would close again for another preprogrammed time period before re-opening. Using an ON/OFF time period helps to preserve battery life and water if the lights should accidentally be left on for an extended period of time.

In another embodiment, the solenoid valve is replaced with a motorized valve, such as a motorized ball valve. The componentry of the system is otherwise the same. In embodiments operating on a DC power source, such as a battery, the motorized valve embodiment drains less battery if the system is left on (i.e., water is allowed to continually flow). The motorized ball valve only uses current when it switches from the open position to the closed position and vice versa. Thus, if the lights in the room containing the valve were left on, the system would not continue to draw current, unlike the solenoid valve. Other motorized valves that could be used with the present invention include motorized gate valves, butterfly valves, globe valves, and plug valves.

In still another embodiment, a housing containing the wireless receiver or photocell switch is adapted to be fixed to the stopcock of a water inlet line. The housing contains a motorized receptacle that engages the stopcock. When the lights are on (i.e., the housing receives a signal from the transmitter or senses the light), the motor rotates the receptacle a preprogrammed amount, such as a quarter-turn. Because the receptacle engages the stopcock, the stopcock also rotates the preprogrammed amount, and the valve is opened to allow the flow of water through the inlet line. When the lights are turned off (i.e., the housing stops receiving a signal from the transmitter or receives an “off” signal from the transmitter or stops sensing the requisite amount of light), the motor rotates the receptacle in the opposite direction through the same preprogrammed amount of rotation. In this embodiment, the valve actuation system is fixed directly to the stopcock, avoiding the need to install the system on the water line.

In order to ensure that the rotational energy is applied to the stopcock and not to the housing, the housing needs to be anchored to something to hold it in place. The anchor can be an arm member that is screwed to the wall, attached to the water inlet line, or mounted to the floor. Additionally, the housing could contain a clamping means or sleeve that engages the water inlet line.

These wireless embodiments have the distinct advantage of avoiding the installation of a wired system. This is particularly advantageous in existing construction and renovations. In the first embodiment of the invention, a wire and perhaps associated chase connects the light switch to the transformer and the transformer to the solenoid. Otherwise, running the wire inside existing walls could be time-consuming and would make installation cumbersome for homeowners. Running the wire outside of the wall, such as along the baseboards, is easier but not as aesthetically pleasing. Without wires, the wireless embodiment is both easier to install and aesthetically pleasing.

As in the invention's first embodiments, the wireless system can be installed on a single fixture, multiple fixtures, or on fluid lines entering a room or home. Additionally, this embodiment can be used to regulate the flow of a variety of fluids, including water, fuel, and gas among others. Additionally, the light switch 25 can be a simple mechanical switch, it can be motion activated, or it can run off of a timer.

One feature that can be included on any of the described embodiments is an indicator light or lights. The indicator light provides quick way to visually inspect whether the solenoid valve is open or closed (i.e., whether water is running through the fluid line). If a single light is used, the light could illuminate when the solenoid valve is closed and darken while the solenoid valve is open, or vice versa. Alternatively, the light could glow a first color if the solenoid is opened or glow a second color if the solenoid is closed. If two lights are used, a light of a first color would illuminate if the solenoid valve is closed and a light of a second color would illuminate if the solenoid valve is open. In this way, the status of the fluid regulation system could easily be evaluated based on whether or what color a single light is illuminated or based on which of multiple lights is illuminated. This visual inspection provides a means for monitoring status of the system without an overhead light being on, and therefor without the entire room being illuminated.

Another feature that can be included on any of the previously described embodiments is a fluid regulation system in which the light switch 25 operates in conjunction with a timer. The timer can be programmable such that the user can input a desired amount of time until the light deactivates; or the timer can come with buttons corresponding to selectable preset time periods. In this way, when the user activates the light 60 using the light switch 25, the solenoid valve 20 will be opened, allowing fluid to flow in the fluid line 55. If the user is performing a task that requires the flow of fluid over an extended period of time, the user would select the amount of time during which the light would remain on. Alternatively, when the light is turned off by the user as he exits the room, the action of turning the light off could engage, or disengage the timer. Thus, for instance if the user is washing clothes or dishes or cooking in an oven or on a stove, the timer would allow for flow to continue in the fluid line until the time period elapses. In previous embodiments, if the user exits the room and shuts the lights off, then flow to these fixtures would cease. In this embodiment, flow in the fluid line to the washing machine, dishwasher, oven, or stove would continue for the desired time period.

### Further Embodiments

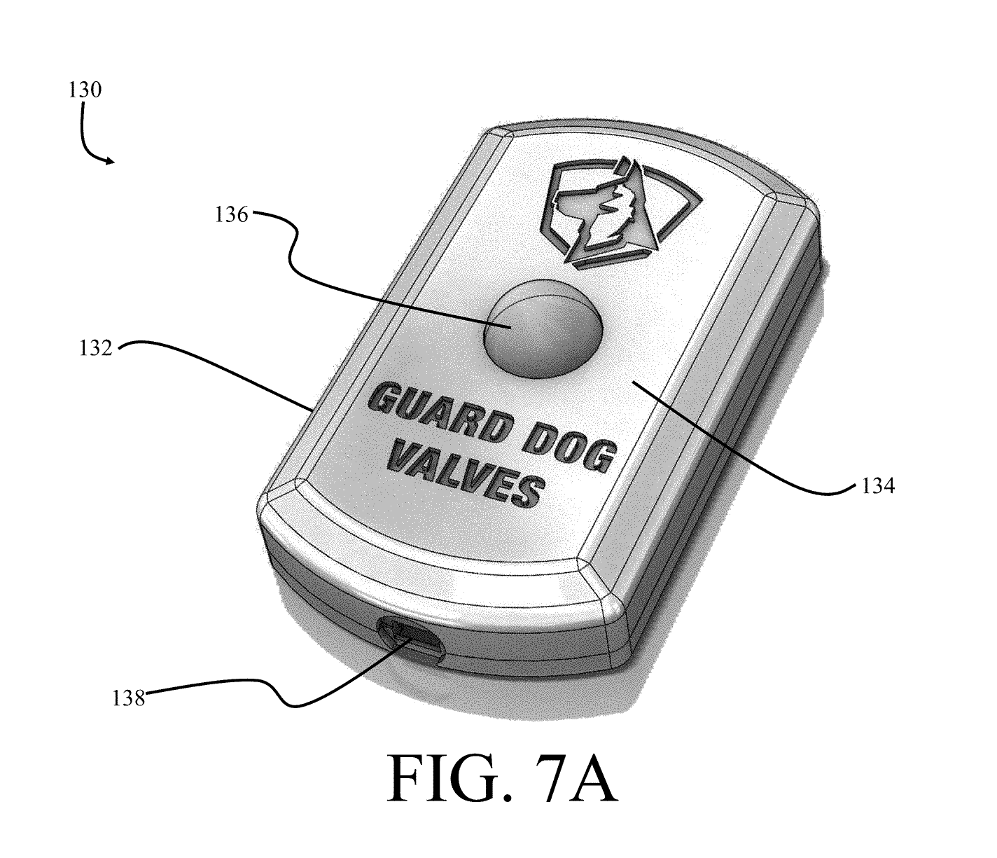

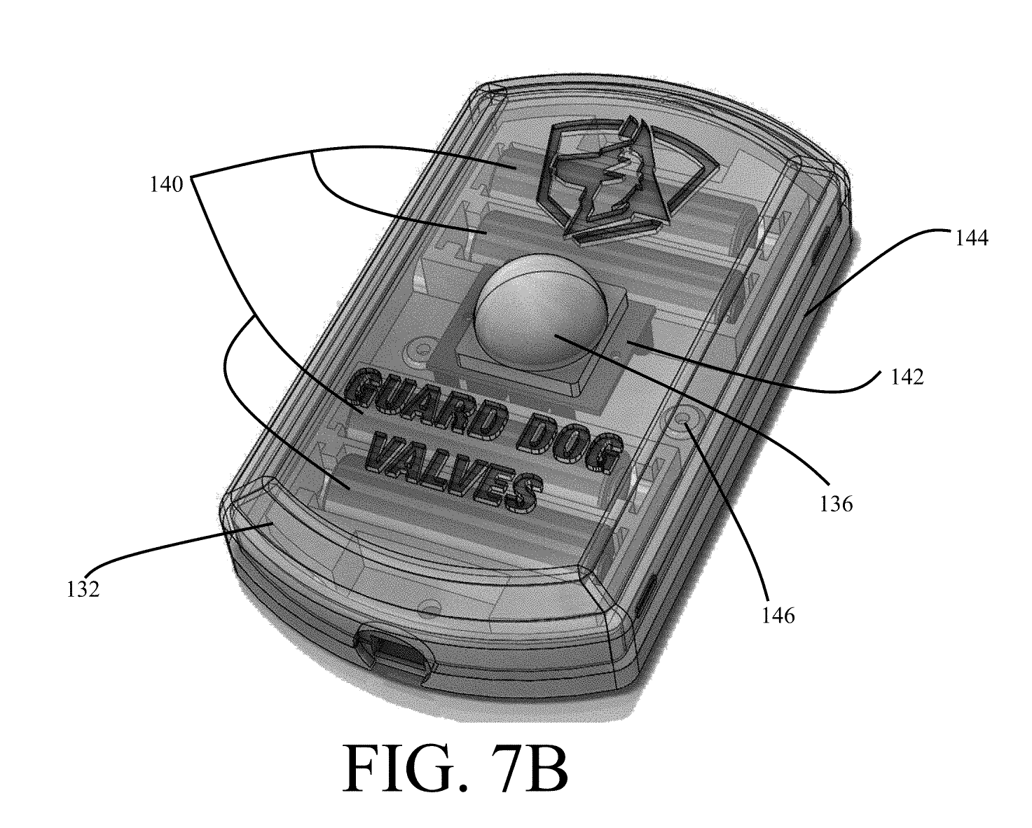

Turning now to FIG. 7A, depicted therein is a further embodiment 130 of a sensor module 132. The sensor module is mounted to a wall of a room, in one embodiment. The sensor module includes a front face 134 with a sensor dome 136 protruding from same. In the depicted embodiment, the sensor dome 136 comprises an occupancy sensor, such as a resistive motion sensor, discussed in detail below. The module 132 also includes at least one aperture 138 to allow for the lifting of the front face 134 so as to be able to access the interior of the sensor module 132. As shown in FIG. 7A, the front face 134 includes indicia to identify the purpose of the sensor module 132 as the sensor module 132 is installed in sensitive areas such as bathrooms.

The details of the interior of the module 132 are shown in FIG. 7B. The module comprises a power supply, and a circuit board 142. As shown in FIG. 7B, the power supply comprises four batteries 140. As shown in FIG. 7B, the batteries 140 are standard AA cells connected in series, providing a total of 6 volts. In one embodiment, the sensor module 132 also includes an led light which begins to blink once the battery voltage dips below a threshold value, such as a total of 5.2 Volts. While the embodiment shown uses four batteries, other power supply arrangements are possible. Also, in the depicted embodiment, the power supply is shown as using batteries, the power supply may comprise a single power cell. In other embodiments, the power supply is hardwired to the sensor.

A circuit board 142 is in electrical communication with the power supply. The circuit board is in communication with the occupancy sensor 136 and also a communications circuit, such as the wireless transmitter 110 discussed in FIG. 6 above. The wireless transmitter 110 is selected to operate for long durations of time on battery power, without needing to transmit large amounts of data. For example, in one embodiment the transmitter is embedded in the circuit board 142 and comprises low power Bluetooth or a RFID tag in communication with the occupancy sensor 136. The back side 144 of the module 132 includes apertures 146 to allow for installation of the module 132 on a wall.

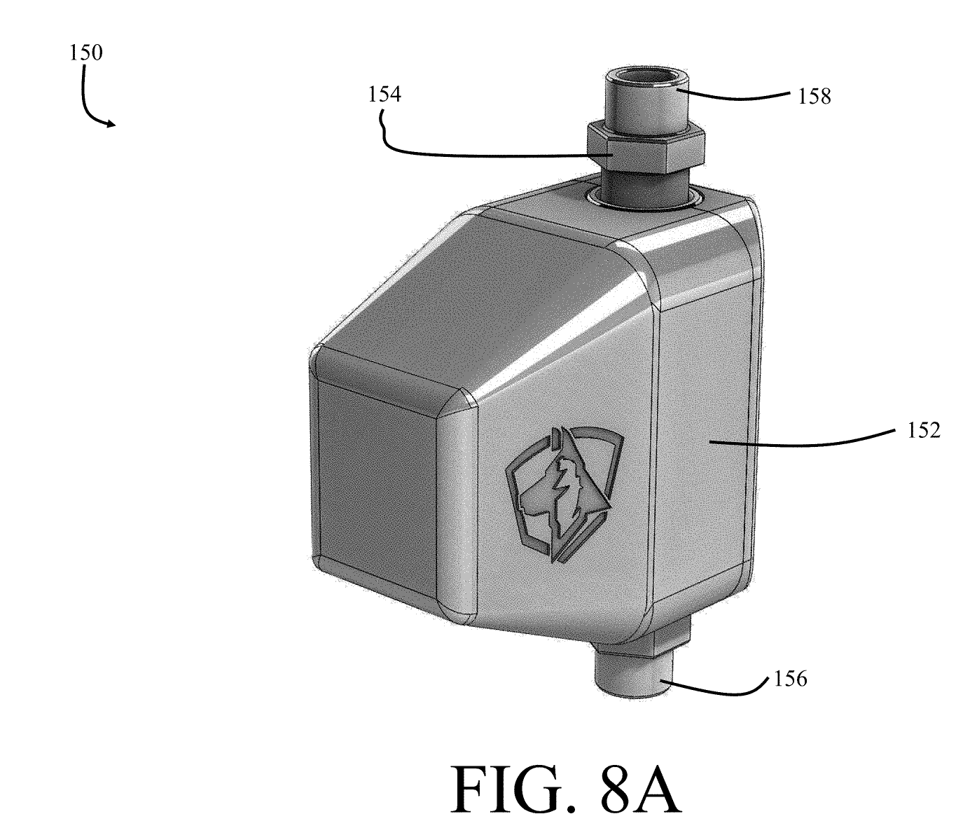

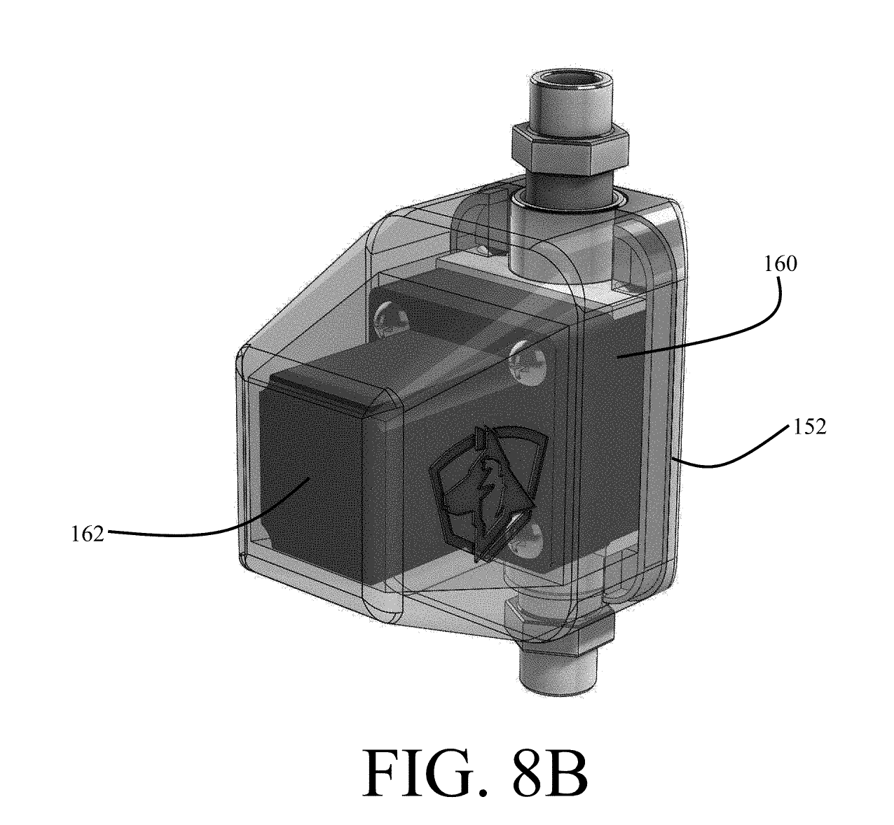

FIG. 8A depicts an embodiment of a valve module 150 to be used in conjunction with the sensor module 130. The valve module 150 includes a body 152 and is installed on a pipe 158 using a hex nut 154 where one end of the pipe is a fluid source 156 and the other end of the pipe 158 leads to a fixture.

The interior of the module body 152 is shown in FIG. 8B. The module body 152 includes a valve 160 and communications module 162. The valve 160 is a latching solenoid valve with a wired connection to a power supply, not shown.

### Single Piece Embodiments

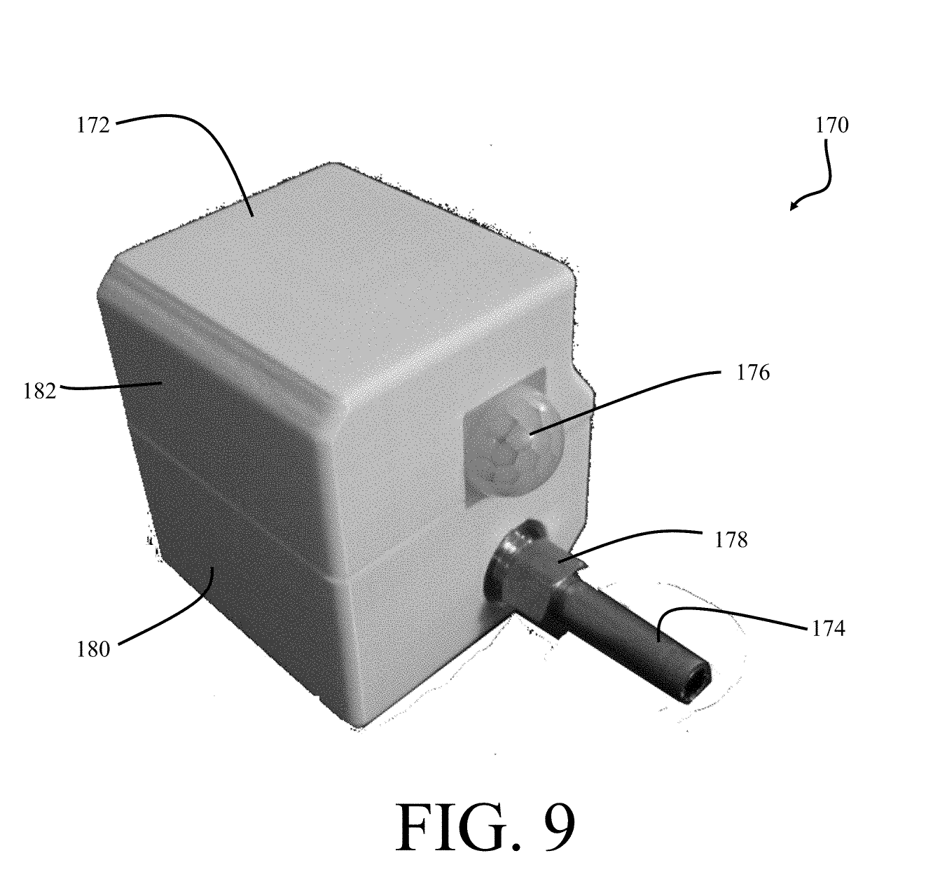

Another embodiment 170 is shown in FIG. 9. The embodiment 170 uses a single piece design for the main body 172. The main body 172 is installed over a pipe 174 where one end leads to a fixture and the other end (not shown) leads to a fluid source. The main body 172 includes an occupancy sensor 176 in communication with an interior valve installed on the pipe 174 inside of the main body 172. The pipe 174 is connected to the main body 172 by using a hex nut 178 and threaded pipe segment, or other conventional means.

The main body 172 includes a lower portion 180 which houses the valve and circuit control board. The lower portion 180 is permanently attached to the pipe 174, in the depicted embodiment, resulting in a water-tight installation. The upper portion 182 includes the power supply and occupancy sensor. In the embodiment shown in FIG. 9, the upper portion 182 is removable to perform tasks such as replacing the power cells. In one embodiment, upon removing the upper portion 182, the end user may adjust the parameters of operation of the valve, such as how sensitive the occupancy sensor 176 is.

The upper portion 182 and the lower portion 180 are molded from single and durable plastic pieces with a snap fit between them. In the embodiment shown in FIG. 9, the valve and sensor 176 are powered by single-use batteries, such as the four AA batteries shown in FIG. 7B. Even in this configuration, standard batteries will last a year, depending on the number of cycles needed for the valve.

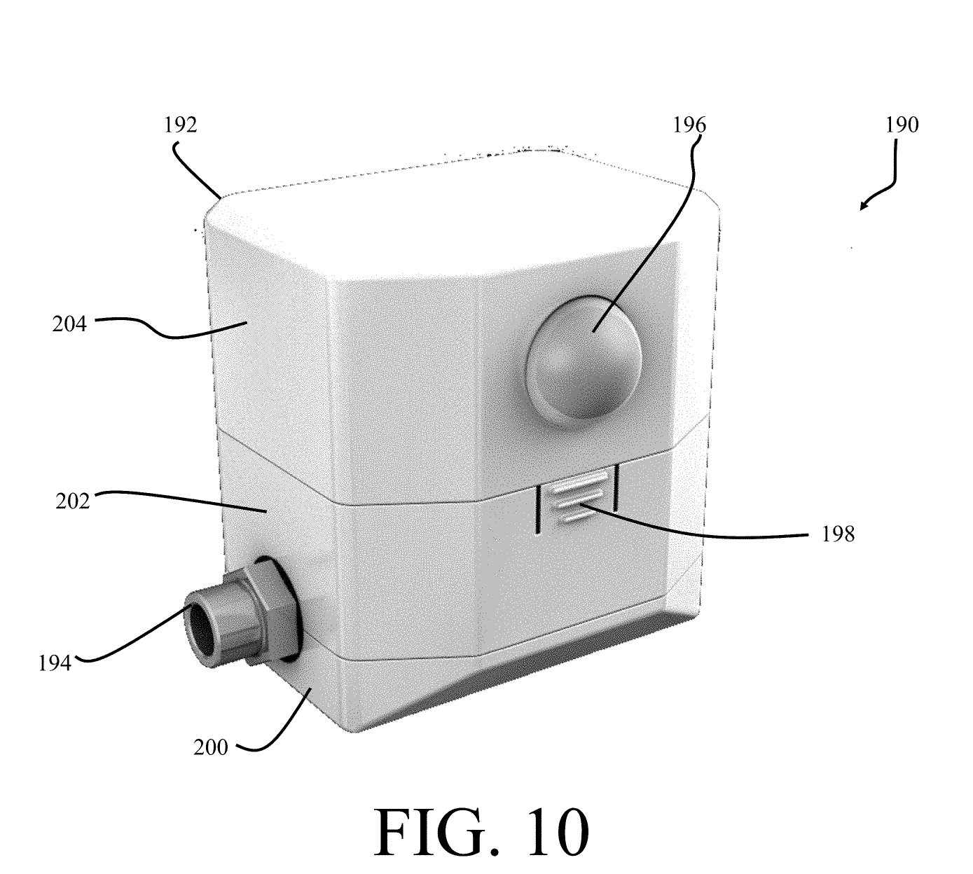

An alternative single piece embodiment 190 is shown in FIG. 10. This embodiment also uses a single-body design with a main body 192. The main body 192 is installed over a pipe 194. Externally, the main body includes only an occupancy sensor dome 196 and an opening area 198. The opening area 198 comprises a reversibly deformable plastic tab.

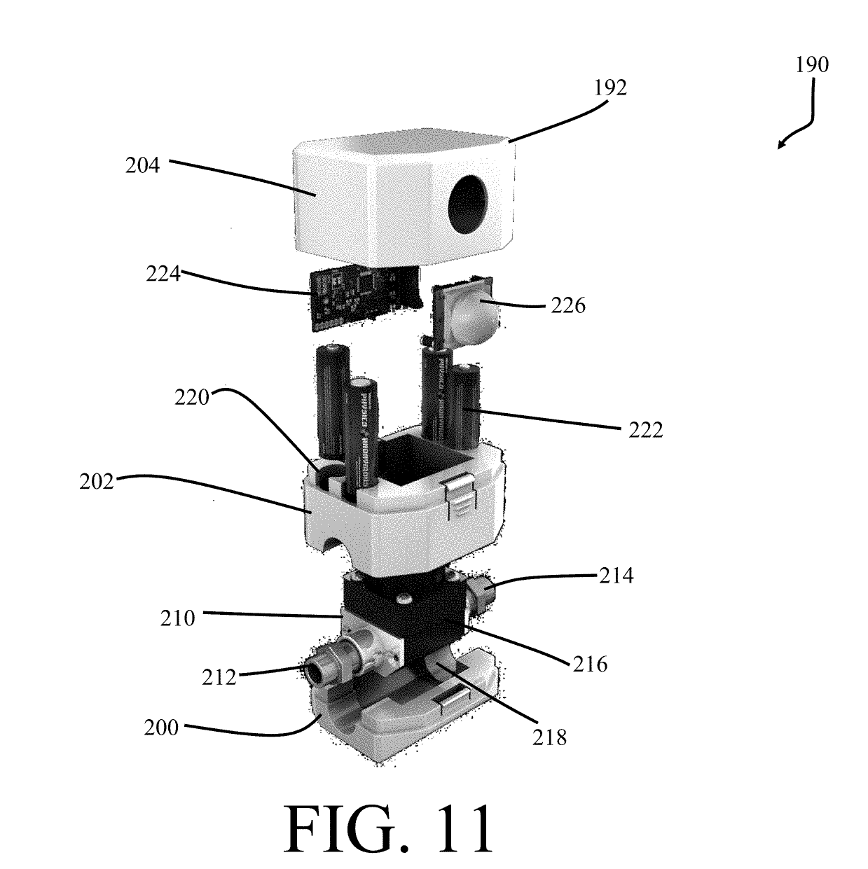

The main body 192 includes a base 200, a middle section 202, and an upper section 204. In the embodiment shown in FIGS. 10 and 11, the upper section 204 is user serviceable and contains the power supply. The middle section 202 holds the valve and is accessed only during the one-time installation. Finally, the base 200 is a tray holding the valve, discussed below.

The internal details of the embodiment 190 are shown in FIG. 11. The base 200 receives the valve module 210. The valve module 210 includes an input pipe 212 and output pipe 214 and a valve 216 between the two pipes 212, 214. The base 200 includes an indentation 218 which results in a tight fit between the valve module 210 and the base 200. A corresponding indentation is defined in the middle section 202 of the main body 192.

The middle section 202 includes slots 220 for batteries 222. The batteries 222 are in electrical communication with one another and the remaining components of the system. In the depicted embodiment, the batteries 222 are connected in series.

The middle section 202 and the upper section 204 are removable so as to allow the end user to replace the batteries 222.

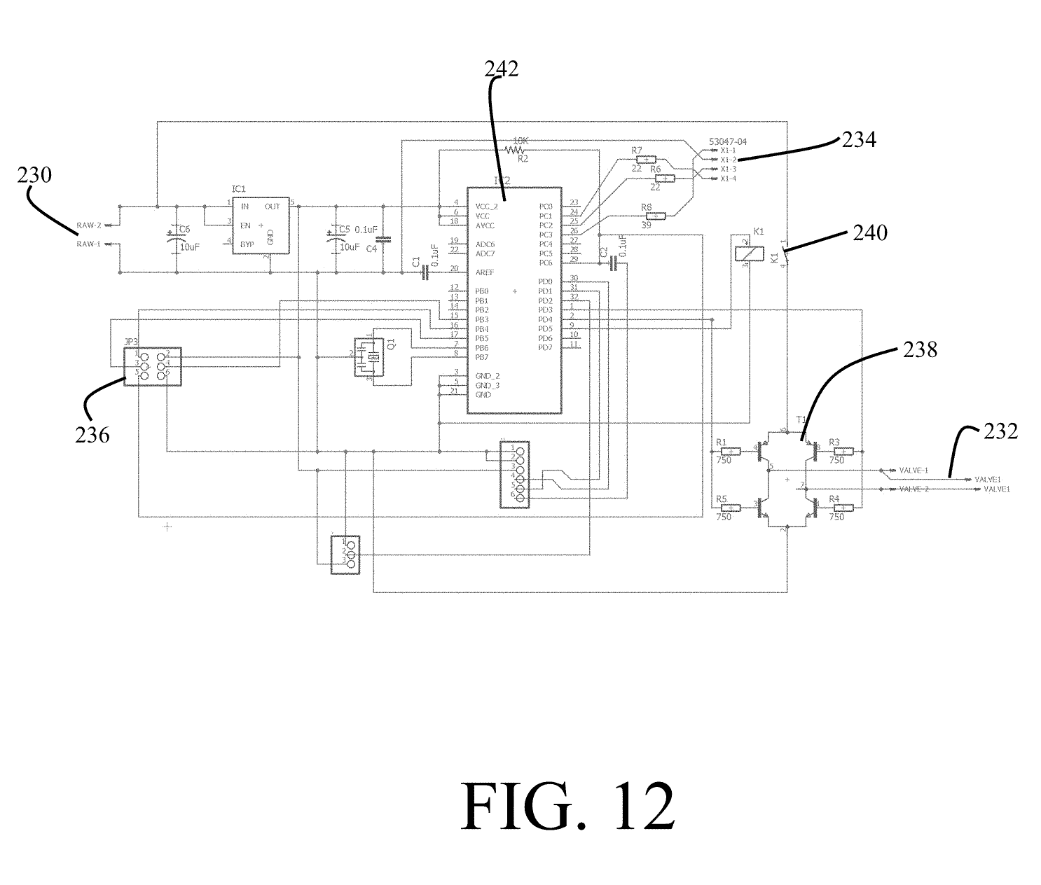

The upper section 204 holds a circuit board 224, the details of which are shown in FIG. 12. The upper section 204 circuit board 224 is also in communication with the occupancy sensor 226. The circuit board 224 provides the logic for the system and control the operation of the valve 216 using the status of the occupancy sensor 226 as the input.

The details of the circuit board 224 are shown in FIG. 12. The circuit board takes as input 230 the signal from the occupancy sensor. The input values are passed to the integrated circuit 242 which also receives the power at the Molex connector 234. The circuit can be switched on and off at the switch 240. The response of the circuit can further be controlled by setting jumpers, such as in block 236.

The output of the circuit is passed to the transformer 238 which then controls the valve output 232.

The circuit shown in FIG. 12 will result in the valve being closed unless the expected signal is received from the occupancy sensor. The opening signal to the valves is passed along for a set period of time, and solely when the motion is occurring. In this operation, the circuit does not cycle the valves unnecessarily.

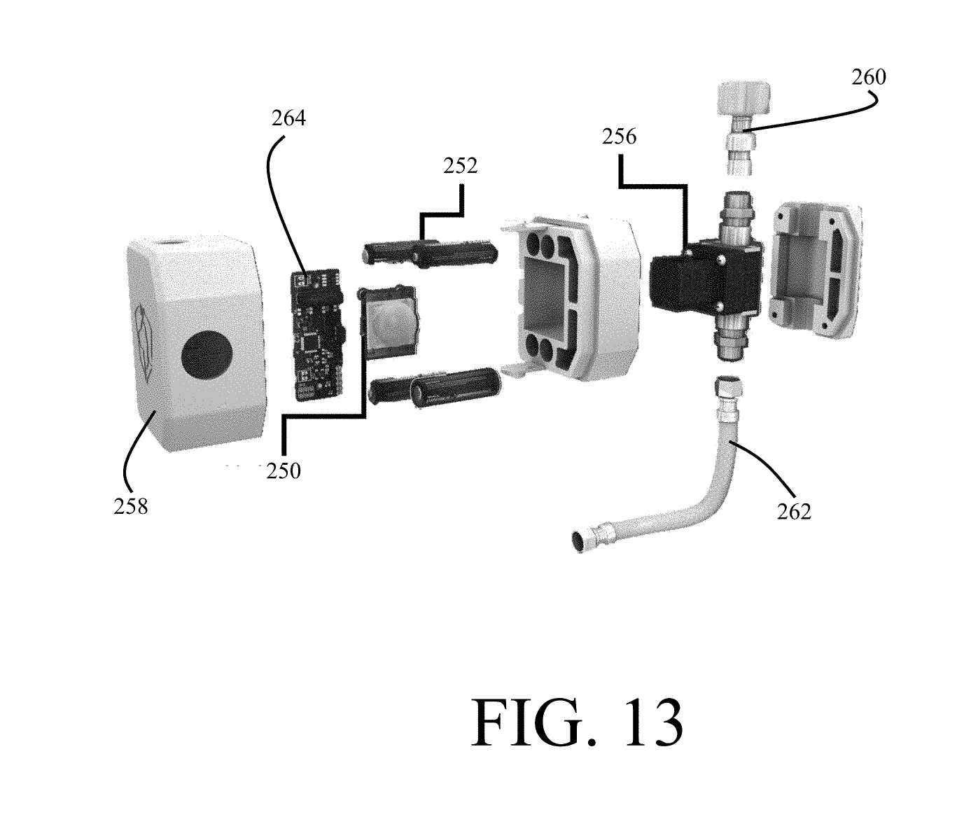

Several of the embodiments described above, and the embodiment shown in FIG. 13, use a 6 DC Volt magnetically latching solenoid valve 256. A benefit of this type of valve is the lower power consumption to switch from open to close. The valve 256 is open while motion is detected and closes when motion ceases. The amount of power required to close the valve is minimal, and the default setting for the valve is to be closed, as will occur if the system power source no longer provides sufficient power. However, at least some power is required to close the valve.

As a 6V valve 256, the solenoid valve is powered by four AA batteries 252, in several embodiments. In other embodiments, the valve is powered by a rechargeable power source, including solar cells on the main body of the valve enclosure.

In several embodiments including the embodiment shown in FIG. 13, the occupancy sensor 250 comprises a passive infrared motion sensor, which opens the solenoid valve when motion is detected. The valve remains open while motion is detected, and for a period afterward.

Following installation of the single component version shown in FIG. 13, only the user serviceable cap 258 will require removal to access the batteries 252 used in the system. The circuit board 264 and motion sensor 250 will be permanently installed.

The valve assembly 256 is connected directly to the toilet tank coupling 260 and the water supply hose 262, in the embodiment shown in FIG. 13. This single-piece design can readily be deployed with few or no tools, depending on the type of coupling used on the existing toilet tank.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. §112(f) unless and until such claim limitations expressly use the phrase “means for” followed by a statement of function void of further structure.

The present methods can involve any or all of the steps or conditions discussed above in various combinations, as desired. Accordingly, it will be readily apparent to the skilled artisan that in some of the disclosed methods certain steps can be deleted or additional steps performed without affecting the viability of the methods.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all subratios falling within the broader ratio.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

An exclusive property right or privilege is claimed in the invention as defined by the following claims:

1. A system to regulate fluid flow, said system comprising:
a single valve interposed on at least one fluid supply line wherein said at least one valve is normally closed, cutting off the flow of fluid in the at least one fluid supply line, wherein the at least one valve is in electrical communication with an occupancy sensor such that when the occupancy sensor is activated the valve is signaled to open, allowing flow of fluid in the fluid supply line.

2. The system of claim 1, wherein the valve is a solenoid valve.

3. The system of claim 2, wherein the solenoid valve is in further electrical communication with a timer, such that the solenoid valve cycles open and closed after a preprogrammed amount of time.

4. The system of claim 3, wherein the solenoid valve is open for a first preprogrammed amount of time and the solenoid valve is closed for a second preprogrammed amount of time.

5. The system of claim 4, wherein the first and second preprogrammed amounts of time are different.

6. The system of claim 1, wherein the system is powered by a DC power source.

7. The system of claim 3, wherein the valve is a motorized valve.

8. The system of claim 4, wherein the valve is a motorized ball valve.

9. The system of claim 1, wherein the wireless transmitter and wireless receiver operate using a wireless signal selected from the group comprising infrared, Bluetooth, and Wi-Fi signals.

10. The system of claim 1, wherein the combination of the solenoid valve and the wireless receiver is in further electrical communication with at least one indicator light.

11. The system of claim 8, wherein the at least on indicator light glows a first color when the valve is closed and glows a second color when the valve is open.

12. The system of claim 8, wherein there are two indicator lights and wherein a first indicator light glows a first color when the solenoid valve is open and a second indicator light glows a second color when the solenoid valve is closed.

13. The system of claim 1, wherein the light switch is a motion activated sensor.

14. The system of claim 1, wherein the light switch is controlled by a timer, such that the light will remain on for a time period set on the timer.

15. A single unit system to regulate fluid flow, said system single unit comprising at least one valve interposed on at least one fluid supply line wherein said at least one valve is normally closed, stopping the flow of fluid in the at least one fluid supply line, wherein the at least one valve is in electrical communication with a photocell switch such that when light is detected the photocell switch allows electrical current flow to the valve, opening the valve and allowing the flow of fluid in the fluid supply line.

16. The system of claim 15, wherein the system is powered by a DC power source.

17. The system of claim 16, wherein the valve is a motorized valve.

18. The system of claim 17, wherein the valve is a motorized ball valve.

19. The system of claim 17, wherein the valve is selected from the group consisting of motorized gate valves, butterfly valves, globe valves, and plug valves.
